(19) United States
(12) Patent Application Publication
(10) Pub. No.: US 2009/0028031 A1
(43) Pub. Date: Jan. 29, 2009

(54) METHOD AND APPARATUS FOR WRITING/READING AN INFORMATION CARRIER AND SUCH AN INFORMATION CARRIER

(75) Inventors: Rong Liu, Shanghai (CN); Goossens Henk, Shanghai (CN); Willem Marie Julia Marcel Coene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/282,179

(22) PCT Filed: Mar. 5, 2007
(86) PCT No.: PCT/IB07/50698

§ 371 Date: Sep. 9, 2008

(30) Foreign Application Priority Data
Mar. 10, 2006 (CN) 200610059532.8

(51) Int. Cl. G11B 7/00

(52) U.S. Cl. 369/100

(57) ABSTRACT

Proposed is a method and apparatus for writing/reading a data block onto/from an information carrier with M-spots schemes and such an information carrier. The method comprises the steps of dividing the data block into N portions according to predetermined writing capacities for each one of the N writers of the M-spots schemes, N and M being integers not less than 2 and N<=M, and writing simultaneously the N portions of data onto the information carrier with the N writers correspondingly. Since all the writers are processing different portions of one data block, the data rate of processing one data block is increased almost N times. Therefore the period that the certain buffer capacity occupied by a data block is decreased substantially, total buffering capacity may be decreased, that means the cost of the schemes is dropped substantially.

### FIELD OF THE INVENTION

The invention relates to a method and an apparatus for writing/reading an information carrier and such an information carrier.

The invention may be used in the field of optical storage.

### BACKGROUND OF THE INVENTION

Mass storage has rapidly progressed over the past few years. Correspondingly, the data rate of storing and reproducing information has improved remarkably. To satisfy the requirement of more efficient data processing, higher data rate should be achieved.

In the technical field of optical storage, one known technology to increase data rates is by increasing the spin speed of an optical disc. But many limitations block the increase of spin speed to be higher, such as operating temperatures. At present, the spin speed has already been high, so it is difficult to get it higher.

Another known technology to increase data rates is multiple-spots schemes. The schemes use parallel multiple beams (multiple writers/readers) to write and/or read data in/from multiple tracks of an optical disc simultaneously, and corresponding to each beam, there is a buffer for buffering data to be written or picked from the optical disc. In some conditions, there is a big buffer with larger buffering capacity for all the writers or readers. The data rate of such schemes can be almost N times of that single-spot schemes can reach, if the multiple schemes have N beams, N being an integer not less than 2.

On a DVD (Digital Versatile Disc) disc, the video data is stored as ECC (Error Correction Code) data blocks. When playing back the disc, before all the data of the ECC data block is accumulated, the error correction cannot be performed. A buffer has to wait for the whole ECC block accumulated before further processing the data block. If there are N readers, every buffer has to wait for the relevant block to be accumulated.

In the multiple-spots schemes, the buffering cost is high since every spot has its own buffer or part of a big buffer. To get a higher data rate, not only N should be larger, but also more buffers should be configured. More spots and more buffers mean higher system complexity and higher cost.

These known technologies have however some limitations to increase the data rate, such as high cost or high temperatures, etc.

### OBJECT AND SUMMARY OF THE INVENTION

It is an object of the invention to propose a method for writing a data block onto an information carrier with M-spots schemes with a higher data rate and less cost. To this end, the method according to the invention comprises steps:
dividing the data block into N portions according to predetermined writing capacities for each one of N writers of the M-spots schemes, N and M being integers not less than 2 and N≦M; and
writing simultaneously the N portions of data onto the information carrier with the N writers correspondingly.

The writing capacity in this invention may be a data quantity or a data proportion that a writer may write in a certain period. The predetermined writing capacity for each one of the N writers may be determined by calculating in the presumed condition that the N writers write different portions of the data block at same time until the sum of all written portions equals to the whole data block, and may be also obtained from a memory.

It is also an object of the invention to propose an apparatus for writing a data block onto an information carrier with M-spots schemes. To this end, the apparatus according to the invention comprises:
a dividing means for dividing a data block into N portions according to predetermined writing capacities for each one of N writers of the M-spots schemes, N and M being integers not less than 2 and N≦M; and
a writing means for writing simultaneously the N portions of data onto the information carrier with the N writers correspondingly.

The writing apparatus may include a calculating means for calculating the writing capacities for each one of the N writers in the presumed condition that the N writers write different portions of the data block at same time until the sum of all written portions equals to the whole data block.

It is also an object of the invention to propose an information carrier that may be read with M-spots schemes. To this end, the information carrier according to the invention comprises more than N disconnected storage areas, N being an integer not less than 2, and a data block, which is composed of N portions, the N portions being stored in N of the disconnected storage area separately. The information carrier may be an optical disc and the N disconnected storage areas may be N adjacent storage tracks.

It is also an object of the invention to propose a method for reading an information carrier proposed according to this invention with M-spots schemes. To this end, the method according to the invention comprises steps:

picking up simultaneously N portions of a data block with N readers of M-spots schemes, N and M being integers not less than 2 and N≦M; and

integrating the N portions into the whole data block.

It is also an object of the invention to propose an apparatus for reading an information carrier proposed according to this invention with M-spots schemes. To this end, the apparatus according to the invention comprises:
a picking up means for picking up simultaneously N portions of a data block with N readers of M-spots schemes, N and M being integers not less than 2 and N≦M; and
an integrating means for integrating the N portions into the whole data block.

Preferably, the N writers/readers of M-spots schemes write/read the N portions on/from the information carrier substantially simultaneously. If the data block cannot be divided into N equal portions, some of the writers may write/read more data and end writing/reading a little later.

The information carrier may be an optical disc, and the writing capacity may be transformed into the track length that a writer may write. Since the sum of N track lengths equals the whole track length of the data block in a continuous spiral form, and those N writers write the N portions substantial simultaneously, it is obvious for a skilled person to get the writing capacity proportion for each of the N writers to the whole required writing capacity of a data block.

Preferably, the N tracks for writing the N portions of the data block are adjacent and parallel. Preferably, the data block may be an integrated data block, such as an ECC block, which cannot be processed unless been integrated as a whole data block.

If N equals to M, only one data block is processed with the M-spots schemes at one time. If M is an even integer, N may be M/2, etc. Preferably, the number of data blocks being processed at one time is an integer.

According to this invention, a data block may be stored in N adjacent tracks in a 2-dimensional way instead of in one single spiral continuous track in a single dimensional way. N portions of the data block are written/read onto/from an optical disc with N writers/readers simultaneously. Therefore the time for accumulating a data block is shortened to almost 1/N comparing to a conventional M-spots schemes or a single spot schemes. Less time is allocated to wait for the accumulation of the whole data block, and the data rate of processing one data block is increased substantively almost N times with less cost.

Further more, by this invention, a data block is accumulated so fast, and the time for a buffer to further process a data block is far less than the accumulating time. Therefore the period that certain buffer capacity occupied by a data block is decreased substantially, total buffering capacity may be decreased, and that means the buffering cost of the M-spots schemes is dropped substantially.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 is a flowchart diagram illustrating a method for writing an optical disc with N writers of M-spots schemes according to one embodiment of the invention;

FIG. 2 is a simplified block diagram showing an apparatus for writing an optical disc with N writers of M-spots schemes according to one embodiment of the invention;

FIG. 3 depicts an information carrier on which an integrated data block is stored as N portions in N tracks according to one embodiment of the invention;

FIG. 4 depicts another information carrier on which an integrated data block is stored as N portions in N tracks according to one embodiment of the invention;

FIG. 5 is a flowchart diagram illustrating a method for reading an optical disc with N readers of M-spots schemes according to one embodiment of the invention; and

FIG. 6 is a simplified block diagram showing an apparatus for reading an optical disc with N readers of M-spots schemes according to one embodiment of the invention.

### DETAILED DESCRIPTION OF THE INVENTION

FIG. 1 is a flowchart diagram illustrating a method for writing an information carrier with N writers of M-spots schemes according to one embodiment of the invention, N and M being integers not less than 2 and N≦M. In this invention, an optical disc is taken as an example of the information carrier.

In an initial step S110, when a data block streams in a writing device with M-spots schemes, the writing capacity for each one of the M-spots schemes is calculated. Hereinafter an ECC block is taken as an example of the data block.

The calculating is conducted in the presumed condition that the N writers write different portions of the data block at same time until the sum of all written portions equals to the whole data block. The writing capacity in this invention means the data quantity the writer may write in the specified conditions, and may be conversed as track length that a writer writes on an optical disc. The writing capacity may also be a data proportion of a data block.

For different optical disc format, the track length of one ECC data block in a continuous spiral form is different and determined. For example, in DVD format, the continuous track length of an ECC block may occupy is around 82.3 mm, and in BD disc format, around 71.9 mm.

Therefore if N writers writes different portions of the data block, the sum of each portions of the ECC block should equal to 82.3 mm when the disc is a DVD format disc, and equal to 71.9 mm when the disc is a BD format disc. Based on the sum and the current position of every writer (for example, the distance from the centre of the disc), the writing capacity or track length of each portion is easy to be calculated for a skilled person.

For a given disc format and a given type data block, the writing capacity of each writer may be stored in a memory for reference, so under such situation, it is not necessary to calculate the writing capacity for every data block's writing and Step 110 may be omitted. Step 110 may be substituted by an obtaining step of obtaining the predetermined writing capacities for each one of the N writers from a reference file, in which the writing capacities of each writer at specified position are listed.

Then, in step S120, the data block is divided into N portions according to the writing capacity for each one of the N writers. Before and after every data portion, some additional information may be added for marking its sequence in the whole data block, for example, sequence number, etc.

In the last step S130, N writers write the N data portions onto the optical disc simultaneously and respectively. All the writers may start and end to write the respective portion of the ECC block at same time, so the ECC block may be written on the disc in 1/N of the time that a conventional M-spots schemes or a single-spot schemes may take. Preferably, those N portions of data may be written onto N adjacent tracks.

By this writing method, the data block may be written in 2 dimensions onto the optical disc and the data rate to process one data block is increased almost N times comparing to a conventional M-spots schemes or single-spot schemes. At same time, the buffer capacity of the writing devices may be decreased and the cost is saved. This method may be implemented with other information carrier with M-spots schemes.

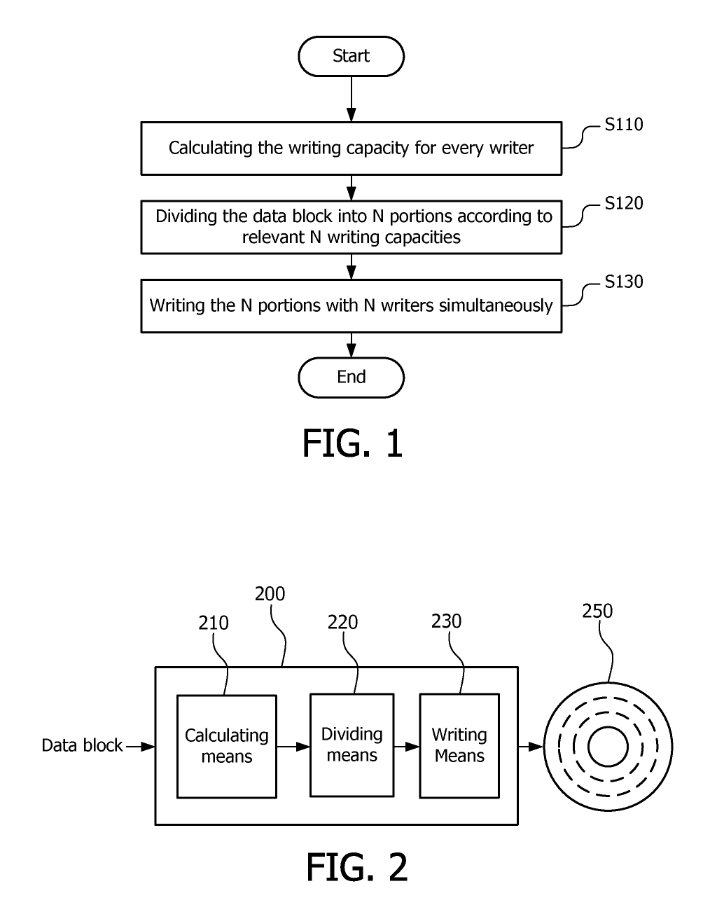

FIG. 2 is a simplified block diagram showing the structure of an apparatus 200 for writing an optical disc 250 with N writers of M-spots schemes according to one embodiment of the invention, N and M being integers not less than 2 and N≦M. The apparatus 200 comprises a calculating means 210, a dividing means 220 and a writing means 230.

When a data block streams in, the calculating means 210 calculates the writing capacity for each one of the N writers. The calculation is conducted in the presumed condition the N writers write different portions of the data block at same time until the sum of all written portions equals to the whole data block.

For a given disc format and a given type data block, if the writing capacity of each writer at a given position is stored in a memory, the calculating means 110 may be substituted by an obtaining means for obtaining the predetermined writing capacities for each one of the N writers from that memory, in which the writing capacities of each writer at specified position are provided.

According to the writing capacities, the data block is divided by the dividing means 220 into N portions. Before and after every data portion, some additional information may be set for marking its sequence in the whole data block.

Then, a writing means 230 write the N data portions onto the optical disc 250 with N writers. N writers write the N portions of data onto the optical disc simultaneously and respectively. All the writers may preferably start and end to write the relevant portion of the ECC block at same time and those N portions of data may preferably be written onto N adjacent tracks of the optical disc 250.

The apparatus 200 may implement the method illustrated in FIG. 1. With the apparatus 200, comparing to conventional M-spots schemes, the time to write an ECC block is shortened to almost 1/N and the data rate to process one ECC block is increased almost N times. At same time, the apparatus 200 may maintain less buffer capacities and the cost is saved.

An information carrier recorder with apparatus 200 and an encoder for encoding information is also proposed, by which the time to process a data block is decreased to almost 1/N, and buffering cost is decreased comparing to that of a conventional M-spots schemes.

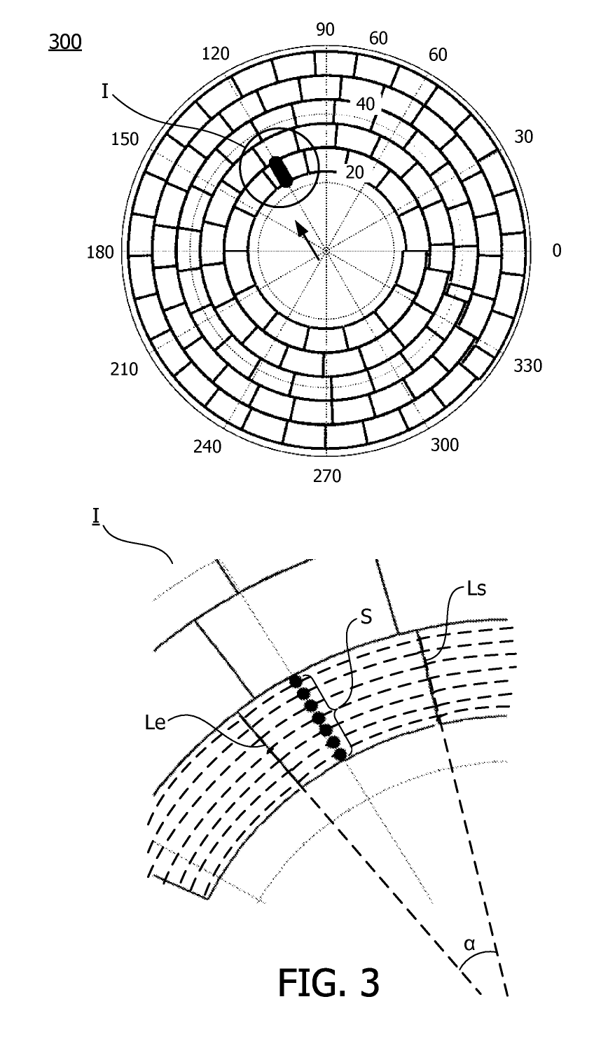

FIG. 3 depicts an information carrier on which a data block is stored as N portions in N adjacent tracks according to one embodiment of the invention. An optical disc 300 is taken as an example of the information carrier. In FIG. 3, every sector-shape quadrangle represents an ECC data block stored on the disc 300. The black ellipse represents N writers aligned in a line in the radial direction indicated by the arrow.

View I is the partial enlarged view of the optical disc 300. View I shows that the optical disc 300 is written with 7 writers, which are marked as spots S collectively. During writing, all the 7 writers start to write from Ls and end writing at Le at same time.

Between the start boundary Ls and the end boundary Le, all the data stored in the 7 tracks belongs to one ECC block. That means the sum of lengths of the 7 tracks between Ls and Le equals a continuous track length of one ECC block in a continuous spiral form. And the track length of a whole data block is defined according to specific optical disc formats. Since all the writers start and end writing respective portions at same time, they rotate the same angle α as shown in FIG. 3. With the semi-diameter of every writer and the whole track length of the data block, it is easy for a skilled person to get the writing capacity for each writer.

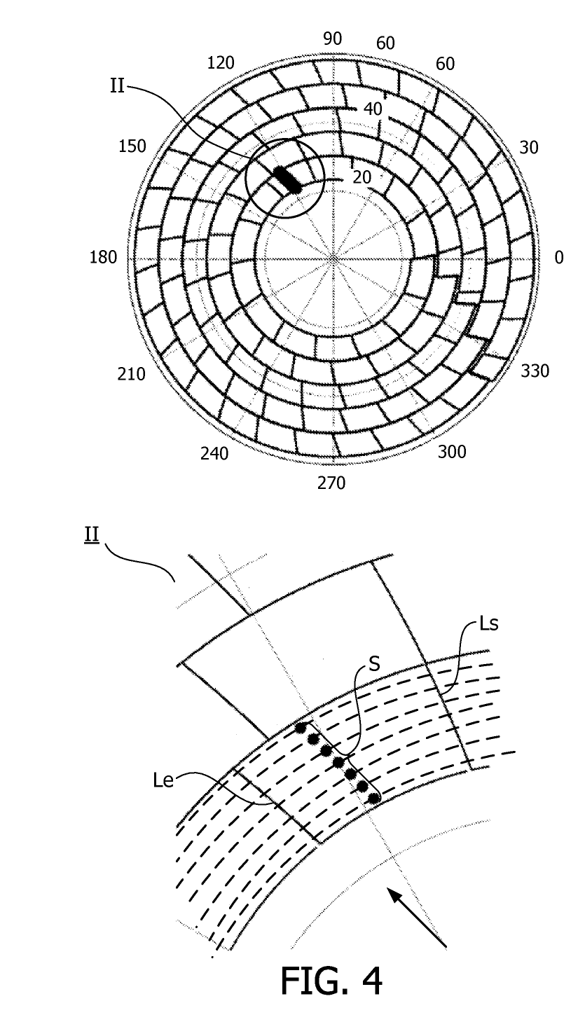

FIG. 4 depicts another information carrier 400 on which a data block is stored as N portions according to one embodiment of the invention. Comparing to the information carrier 300 shown in FIG. 3, the difference is that the area storing the data block is more like a rectangle instead of sector shape quadrangle, therefore the 7 data portions are almost same. That means the writing capacity of every writer may be same.

Those 7 writers may align in a line as shown in FIG. 4, and they also may be arranged in track direction on different tracks.

For a blank optical disc with specified format, except the information of the writing capacities for each writer on the disc, the manufacture may also store the allocation and link information of every portion of a data block for reference.

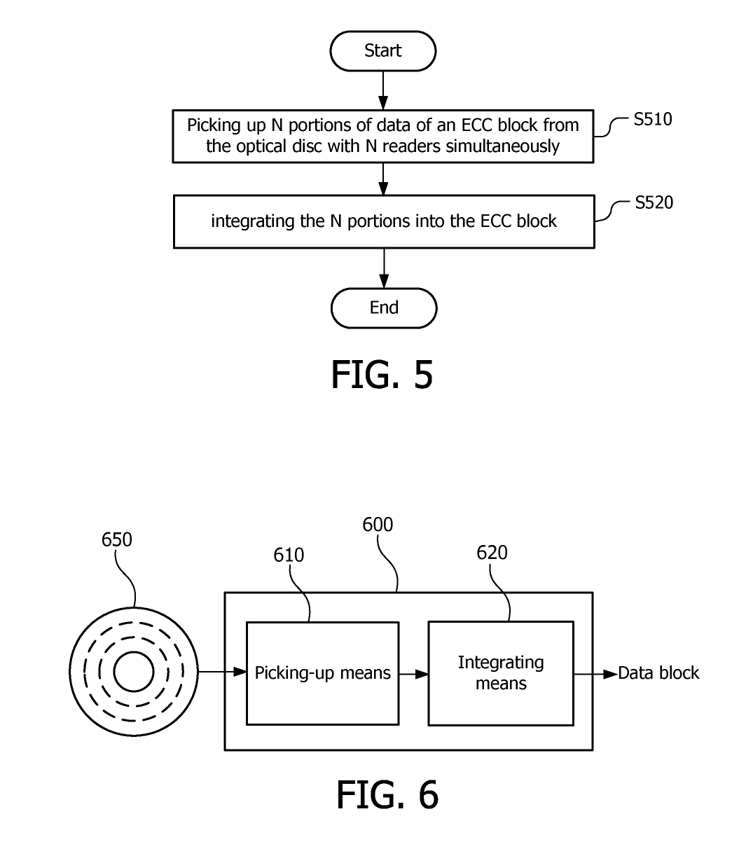

FIG. 5 is a flowchart diagram illustrating a method for reading an optical disc with N readers of M-spots schemes according to one embodiment of the invention, N and M being integers not less than 2 and N≦M.

In the first step S510, when an optical disc proposed in this invention is inserted into an optical disc player with M-spots schemes, the N readers pick up the N portions of a data block simultaneously.

Preferably, these N portions are picked up at same time, that is, N writers start and end reading at same time unless the sizes of portions are different. Those N portions of data may be accumulated in 1/N of the time that a data block is picking up with only one reader.

In the sequence step S520, N portions are integrated together into a whole data block. After N portions are picked up, they are integrated together according to their specified sequences in the whole data block.

As mentioned above, when the data block is divided into N portions, before and after every data portion, some additional information may be set for marking its sequence in the whole data block. Therefore according to these marks, the portions are integrated into one data block. After the data block is integrated, it may be processed further, for example, performing error correction.

By this reading method, the data rate to process one ECC block is increased almost N times and the buffering cost is decreased comparing to conventional M-spots schemes.

FIG. 6 is a simplified block diagram showing an apparatus 600 for reading an optical disc 650 with N readers of M-spots schemes according to one embodiment of the invention, N and M being integers not less than 2 and N≦M. The apparatus 600 comprises a reading means 610 and an integrating means 620. The apparatus 600 may implement the method illustrated in FIG. 5.

In FIG. 6, the reading means 610 with N readers of M-spots schemes pick up N portions of a data block simultaneously from an optical disc 650 as proposed in this invention.

These N portions may be picked up at same time, that is, N readers start and end reading N portions at same time. Therefore N portions of data may be accumulated in 1/N of the time that a data block is picking up with only one reader in conventional M-spots schemes.

Then, the integrating means 620 integrates the accumulated N portions into one integrated data block. After N portions are picked up, they are integrated together according to their specified sequences in the data block.

By the reading apparatus 600, the data rate to process one ECC block is increased almost N times and buffering cost is decreased, comparing to conventional M-spots schemes.

An optical disc player with apparatus 600 and an decoding means is proposed in this invention, with which the data rate to process a data block is increased almost N times and buffering cost is decreased comparing to that in conventional M-spots schemes.

The methods, apparatus, player and recorder proposed in this invention may be implemented multi-spirals discs as well as single spiral discs.

According to this invention, the schemes to write/read an ECC block could be 2-dimensional one instead of one-dimensional type. Therefore the data rate to processing one data block is increased substantially. At the same time, less buffering capacities are needed, so cost is dropped and the high data rate is realized.

Use of the verb “comprise” and its conjugations does not exclude the presence of elements or steps other than those stated in the claims. Use of the article “a” or “an” preceding an element or step does not exclude the presence of a plurality of such elements or steps.

1. A method for writing a data block onto an information carrier with M-spots schemes, comprising the steps of:
dividing the data block into N portions according to predetermined writing capacities for each one of the N writers of the M-spots schemes, N and M being integers not less than 2 and N≦M; and
writing simultaneously the N portions of data onto the information carrier with the N writers correspondingly.

2. A method as claimed in claim 1, the predetermined writing capacities are determined by a step of:
calculating writing capacities for each one of the N writers in the presumed condition that the N writers write different portions of the data block at same time until the sum of all written portions equals to the whole data block.

3. A method as claimed in claim 1, further comprising the step of:
obtaining the predetermined writing capacities for each one of the N writers from a memory, in which the writing capacities are provided.

4. A method as claimed in claim 1, 2 or 3, wherein the data block is an integrated data block.

5. A method as claimed in claim 4, wherein the integrated data block is an ECC data block.

6. A method as claimed in claim 1, 2 or 3, wherein the information carrier is an optical disc and the N data portions are written in N adjacent tracks of the optical disc.

7. An apparatus for writing a data block onto an information carrier disc with M-spots schemes, comprising:
a dividing means for dividing the data block into N portions according to predetermined writing capacities for each one of the N writers of the M-spots schemes, N and M being integers not less than 2 and N≦M; and
a writing means for writing simultaneously the N portions of data onto the information carrier with the N writers correspondingly.

8. An apparatus as claimed in claim 7, further comprising:
a calculating means for calculating the writing capacities for each one of the N writers in the presumed condition that the N writers write different portions of the data block at same time until the sum of all written portions equals to the whole data block.

9. An apparatus as claimed in claim 7, further comprising:
an obtaining means for obtaining the predetermined writing capacities for each one of the N writers from a memory, in which the writing capacities are provided.

10. An apparatus as claimed in claim 8 or 9, wherein the data block is an integrated data block.

11. An apparatus as claimed in claim 10, wherein the data block is an ECC data block.

12. A method as claimed in claim 7, 8, or 9, wherein the information carrier is an optical disc and the N data portions are written in N adjacent tracks of the optical disc.

13. An information carrier recorder, comprising:
an editor for editing information into a data block; and
an apparatus for writing the data block onto an information carrier with M-spots schemes, comprising,
a dividing means for dividing the data block into N portions according to predetermined writing capacities for each one of the N writers of the M-spots schemes, N and M being integers not less than 2 and N<M, and
a writing means for writing simultaneously the N portions of data onto the information carrier with the N writers correspondingly.

14. An information carrier, comprising
more than N disconnected storage areas, N being an integer not less than 2; and
a data block, which is composed of N portions, the N portions being stored in N of the disconnected storage area separately.

15. An information carrier as claimed in claim 14, wherein the information carrier is an optical disc and the N disconnected storage areas are N adjacent storage tracks.

16. A method for reading an information carrier as claimed in claim 14 or 15 with M-spots schemes, the method comprising steps of:
picking up simultaneously N portions of a data block with the N readers of the M-spots schemes, N and M being integers not less than 2 and N≦M; and
integrating the N portions into the whole data block.

17. An apparatus for reading an information carrier as claimed in claim 14 or 15 with M-spots schemes, the apparatus comprising:
a picking up means for picking up simultaneously N portions of a data block with the N readers, N and M being integers not less than 2 and N≦M; and
an integrating means for integrating the N portions into the whole data block.

18. An information carrier comprising a memory that provides predetermined writing capacities for each writer of M-spots schemes, M being an integer not less than 2.

19. An information carrier as claimed in claim 18, comprising the allocation information for every portion of a data block, the portions being divided from the data block according to the writing capacities.
